(19) United States
(12) Patent Application Publication
(10) Pub. No.: US 2014/0312282 A1
(43) Pub. Date: Oct. 23, 2014

(54) BATTERY BINDER

(71) Applicant: E I DU PONT DE NEMOURS AND COMPANY, WILMINGTON, DE (US)

(72) Inventor: Chongsoo Lim, Hockessin, DE (US)

(73) Assignee: E I DU PONT DE NEMOURS AND COMPANY, WILMINGTON, DE (US)

(21) Appl. No.: 14/259,841

(22) Filed: Apr. 23, 2014

Related U.S. Application Data
(60) Provisional application No. 61/815,153, filed on Apr. 23, 2013.

(51) Int. Cl. H01M 4/62; H01M 4/136

(52) U.S. Cl. CPC H01M 4/622; H01M 4/136
USPC 252/511; 524/548; 524/315; 252/519.33; 252/512; 252/500; 252/519.34

(57) ABSTRACT

Disclosed is a composition comprising an ethylene copolymer and a solvent wherein the composition is a binder for a lithium ion battery; the ethylene copolymer comprises or is produced from repeat units derived from ethylene and a comonomer selected from the group consisting of an ∝, β-unsaturated monocarboxylic acid or its derivative, an ∝, β-unsaturated dicarboxylic acid or its derivative, an epoxide-containing monomer, a vinyl ester, or combinations of two or more thereof; and the composition can further comprises a curing agent to crosslink the ethylene copolymer.

This application claims priority to U.S. provisional application No. 61/815153, filed Apr. 23, 2013; the entire disclosure of which is incorporated herein by reference.

The invention relates to binder and its use in a secondary battery, such as lithium ion battery.

### BACKGROUND OF THE INVENTION

Since commercial lithium ion batteries were first developed by Sony early 1990s, they have been widely adopted in portable electronics such as laptops, tablets and smartphones due to their high energy density, high working voltages, and excellent flexibilities in shapes and sizes. These properties allow lithium ion batteries to accommodate demanding needs from rapidly evolving electronic devices more readily than conventional secondary batteries. Lithium ion batteries are considered as greener alternative energy sources in emerging markets such as electrified vehicles and energy storage, which will bring about new opportunities and challenges simultaneously.

A lithium ion battery (LIB) typically comprises four components including a negative electrode (anode), a positive electrode (cathode), a separator, and an electrolyte, which work in harmony to interconvert chemical energy into electrical energy reversibly as current flow reverses during charge and discharge process. Typically electrodes are constructed by applying active material onto current collector in the presence of binder that affords cohesion between active materials and their adhesion to current collector. The binder is commonly combined with carbon black for electric conductivity. Common active material for anodes is carbon (graphite) or silicon, and, for cathode, lithium metal oxides, mixed metal oxides, or metal salts of usually lithium. Current collector for anode is typically Cu, and Al is for cathode. The electrolyte can be a mixture of organic carbonates containing lithium salts. The organic carbonates can include ethylene carbonate, ethyl methyl carbonate, diethyl carbonate, or combinations thereof. The lithium salts can include LiPF₆, LiAsF₆, LiClO₄, LiCF₃SO₃, LiN(SO₂CF₃)₂ or combinations thereof. The separator is commonly made from stretched and thus micro-porous multi-layered film of polyethylene, polypropylene or combinations thereof.

Widely used binders comprise homopolymers and copolymers of polyvinylidene fluoride (PVDF), which have gained success as binders for cathodes and anodes in lithium ion battery technology. PVDF and copolymers such as p(VDF-HFP) (copolymer of vinylidene fluoride and hexafluoropropylene) are also utilized as polymer electrolytes and separators by itself or in combination with other materials. PVDF might have suitable properties for lithium ion battery application such as relatively wide redox window for electrochemical stability, high molecular weight for strong adhesion to current collector and robust cohesion between active materials, high polarity to increase compatibility with polar cathode active material and proper viscosity, and commercial availability in high purity. However, it is sometimes reported that PVDF needs improvement in adhesion, percent active loading, swelling behavior and flexibility. N-methyl-2-pyrrolidone (NMP), a typical solvent for PVDF, might need to be deselected at a certain point due to its toxicity. As the recent trends in portable electronics become slimmer and more flexible, the drawbacks of PVDF can be magnified depending on specific applications.

In addition to PVDF, polyolefinic materials with electron withdrawing substituents such as poly(methyl methacrylate)(PMMA), polyacrylic acids, polyacrylronitrile (PAN) and polyvinyl chloride (PVC) have been adopted in lithium ion battery technology. Functionalized copolymeric ethylene copolymers with similar structures of above examples also have performance qualities that can be utilized as a binder material for lithium ion battery such as robust adhesion to the current collector, stronger binding, suitable swelling in electrolytes, higher active material loading, excellent flexibility and a comparable operating (redox/thermal) window. However, it would be a great contribution to the art if other polymers can be used in a battery binder system. An ethylene copolymer such as ELVALOY®, NUCREL® and SURLYN® currently produced and marketed by E. I. du Pont de Nemours and Company, Delaware, USA (DuPont) was then discovered as a suitable polymer for used in the binder. Such ethylene copolymer-based binder systems can be designed to crosslink during the cathode manufacturing process. Additionally, an ethylene copolymer can use non-NMP-based solvents for cost saving, facilitated dry/cure processing, and minimized hazard issues.

### SUMMARY OF THE INVENTION

A composition comprises an ethylene copolymer and a solvent wherein the composition can be used as LIB cathode binder; the ethylene copolymer comprises repeat units derived from ethylene and a comonomer; the solvent can be one that is known to one skilled in the art such as a hydrocarbon, ether, ketone, ester, or combinations of two or more thereof; and the comonomer can be an ∝, β-unsaturated monocarboxylic acid or its derivative, an ∝, β-unsaturated dicarboxylic acid or its derivative, an epoxide-containing monomer, a vinyl ester, or combinations of two or more thereof. Optionally the carboxylic acid moiety can be partially or fully neutralized with a metal or an amino cation.

An electrode can comprise a metal oxide, mixed metal oxide, metal phosphate, metal salt, or combinations of two or more thereof and a binder composition wherein the binder composition can be as disclosed above.

### BRIEF DESCRIPTION OF DRAWINGS

FIG. 1 is a plot of discharge of a coin cell against number of charge and discharge cycle.

FIG. 2 represents Coulombic efficiency of the coin cell shown in FIG. 1.

### DETAILED DESCRIPTION OF THE INVENTION

A comonomer disclosed herein does not comprise a comonomer having (1) an alkyl group containing more than 3 four carbon atoms, (2) a nitrogen-containing comonomer, (3) an aromatic comonomer, (4) a conjugated diene, or (5) combinations of two or more of (1), (2), (3) and (4). The description following the verb “is” can be a definition.

An ∝, β-unsaturated monocarboxylic acid or its derivative can include an (meth)acrylic acid including acrylic acid, methacrylic acid, methacrylate, alkyl acrylate, or combinations of two or more thereof. Similarly, alkyl (meth)acrylate can include alkyl acrylate or alkyl methacrylate such as methyl acrylate, methacrylate, ethyl acrylate, butyl acrylate, or combinations of two or more thereof.

An ∝, β-unsaturated dicarboxylic acid or its derivative can include maleic acid, fumaric acid, itaconic acid, a C₁-C₄ alkyl monoester of maleic acid, a C₁-C₄ alkyl monoester of fumaric acid, a C₁-C₄ alkyl monoester of itaconic acid, acid anhydride, or combinations of two or more thereof.

An epoxide-containing monomer can include glycidyl methacrylate, glycidyl acrylate, or combinations thereof.

An example of vinyl ester can be vinyl acetate.

An ethylene copolymer can be a dipolymer, a terpolymer, a tetrapolymer, or combinations of two or more thereof.

An ethylene copolymer may be disclosed as E/X/Y, or E/X/Y/X′ copolymers where E represents copolymerized units of ethylene. X and X′ can be the same or different and can represent copolymerized units of an α,β ethylenically unsaturated carboxylic acid, dicarboxylic acid, or both. Y represents copolymerized units of another comonomer. X and X′ can be present from 0 or 5 to about 50, alternatively about 12 to about 30, or about 15 to about 25, weight % of the total weight of the copolymer. Y can be from 0 or about 0.1 to about 50, alternatively about 1 to about 40 weight % of the total weight of the copolymer. However, X, X′, and Y cannot be 0 in the same polymer molecule.

Preferred examples include copolymers where X is from about 15 to about 25% of the copolymer weight and the amount of X′ and Y is 0. When present, Y may be 0 to about 50 or about 5 to about 20 weight % of the copolymer and preferably Y is alkyl acrylate and alkyl methacrylate, where the alkyl groups have from 1 to 4 carbon atoms. Examples include copolymers where X is 0 or from about 15 to about 25 weight % of the copolymer and the amount of Y is 0 or from about 5 to about 20 weight % of the copolymer.

When Y is 0, an E/X/Y copolymer is an ethylene acid copolymer, which may be made by any suitable method. For example, an ethylene acid copolymer can be produced by a method disclosed in U.S. Pat. No. 5,028,674, the disclosure of which is incorporated herein by reference. Because such methods are so well known, their description is omitted herein for the interest of brevity.

Such ethylene acid copolymer preferably comprises repeat units derived from ethylene and a C₃₋₈ α,β ethylenically unsaturated carboxylic acid such as acrylic acid or methacrylic acid.

Examples of ethylene acid copolymers include ethylene acrylic acid dipolymer, ethylene methacrylic acid dipolymer, ethylene methyl acrylic acid dipolymer, ethylene ethyl acrylic acid dipolymer, ethylene butyl acrylic acid dipolymer, ethylene methyl acrylic acid glycidyl methacrylate terpolymer, ethylene butyl acrylic acid glycidyl methacrylate terpolymer, or combinations of two or more thereof. Acid copolymer frequently referred to is NUCREL®, available from DuPont.

When an ethylene acid copolymer is neutralized with a metal or amino cation, it becomes an ionomer. Ionomer may be produced from its corresponding acid copolymer by methods known in the art of preparing ionomers, such as disclosed in U.S. Pat. No. 3,262,272, the disclosure of which is incorporated herein by reference. An ionomer can have about 1 to about 100% of the acid moieties of its corresponding acid copolymer nominally neutralized by a combination of a metal or amino cation such as those well-known to one skilled in the art including an alkali metal, alkaline earth metal, or transition metal. An ionomer is well-known to one skilled in the art, the description of which is omitted herein for the interest of brevity. Examples of ionomers include ethylene acrylic acid dipolymer, ethylene methacrylic acid dipolymer, ethylene methyl acrylic acid dipolymer, ethylene ethyl acrylic acid dipolymer, ethylene butyl acrylic acid dipolymer, ethylene methyl acrylic acid glycidyl methacrylate terpolymer, ethylene butyl acrylic acid glycidyl methacrylate terpolymer, or combinations of two or more thereof where the acid moieties are partially or fully neutralized with a metal or amino cation as disclosed above. An ionomer frequently referred to by one skilled in the art is SURLYN®, also available from DuPont.

An acid copolymer may optionally contain a softening monomer. Softening means that a polymer is made less crystalline. When a softening comonomer is included, the corresponding ionomer becomes softer. Suitable examples of “softening” comonomers are monomers selected from the group consisting of alkyl acrylate and alkyl methacrylate, wherein the alkyl groups preferably have from 1 to 4 carbon atoms. An ionomer may comprise at least one E/X/Y or E/X copolymer as disclosed above. A mixture of two or more different acid copolymers may be used in the ionomer composition in place of a single copolymer. An ionomer can be made from such acid copolymer by neutralization as disclosed above.

An ionomer can be further modified by combining the ionomer with an organic acid or its derivative to produce an organic acid-modified ionomer. The organic acids can be aliphatic, mono-functional (saturated, unsaturated, or multi-unsaturated) organic acids, such as those having fewer than 36 carbon atoms. The derivative can be a salt of the organic acid. The salts may be any of a wide variety, including the barium, lithium, sodium, zinc, bismuth, potassium, strontium, magnesium, or calcium salts of the organic acids. Examples of such acids include C₄ to less than C₃₆, C₆ to C₂₆, C₆ to C₁₈, or C₆ to C₁₂, organic acids. Of interested organic acids include caproic acid, caprylic acid, capric acid, lauric acid, stearic acid, behenic acid, erucic acid, oleic acid, and linoelic acid.

The modification can be carried out by melt-blending ethylene α,β ethylenically unsaturated C₃₋₈ carboxylic acid copolymer(s) or ionomer(s) thereof that are not neutralized to the level that they have become intractable (not melt-processable) with one or more organic acids or derivatives thereof, and, concurrently of subsequently, adding, or combining the acid copolymer or ionomer with, a sufficient amount of a cation source to increase the level of neutralization all the acid moieties (including those in the acid copolymer and in the organic acid) to greater than 90%, preferably near 100%, more preferably to 100%.

When X, in the above illustrated E/X/Y copolymer, is 0 the ethylene copolymer becomes an ethylene carboxylate copolymer. Examples of such ethylene copolymers include ethylene acrylate dipolymer, ethylene methacrylate dipolymer, ethylene methyl acrylate dipolymer, ethylene ethyl acrylate dipolymer, ethylene butyl acrylate dipolymer, ethylene methyl acrylate glycidyl methacrylate terpolymer, ethylene butyl acrylate glycidyl methacrylate terpolymer, or combinations of two or more thereof. An ethylene frequently referred to by one skilled in the art is ELVALOY®, manufactured and marketed by DuPont.

The functions of binder in electrode of lithium ion battery can involve adhesion to current collector and cohesion between active materials, which are known to be dependent on molecular weight of the binder. The higher the molecular weight of the binder the stronger the adhesion and the cohesion. Since trends in lithium ion battery moves toward slimmer and more flexible structures, the role of binder to accommodate functional needs becomes even more demanding. It may be desirable to use multifunctional additives with an ethylene copolymer to build up its molecular weight, which can be readily achieved in existing lithium ion battery drying and annealing processes. Examples of multifunctional additives can include trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, phthalic anhydride, trimellitic anhydride, pyromellitic anhydride, benzophenone tricarboxylic anhydride, ethylene glycol bistrimellitate, glycerol tristrimellitate, alkylstyrene-maleic anhydride copolymer, polyazelaic polyanhydride, polyether amines such as JEFFAMINE®, 1,2,4-benzenetricarboxylic anhydride, bisphenol A, bisphenol A esters, bisphenol A diglycidyl ethers, 1,2-cyclohexanedicarboxylic anhydride, trimethylolpropane tris[poly(propylene glycol), amine terminated] ether, polyamide made from fatty dimer acid (such as VERSAMID®), polyamines, triethylenediamine, 2,4,6-tris(dimethylaminomethyl)phenol, liquid polymercaptan, and polysulfide resin, various kinds of carbodiimides including their derivatives, and various kinds isocyanides including their derivatives.

It is accordingly desirable to increase the molecular weight of an ethylene copolymer by, for example, crosslinking with a curing agent. The ingredients, including the copolymer, cure agents, additives, and/or additional polymers, can be mixed in known equipment such as an internal mixer (e.g., a Banbury mixer), a two-roll mill and other similar mixing devices known in the art to achieve a well-dispersed mixture. After compounding, the compositions can be crosslinked to increase molecular weight.

For example, a blend of the un-crosslinked ethylene copolymer and a curing agent, optionally other additive(s) and/or polymers can be subject to a curing step at sufficient time, temperature to achieve covalent chemical bonding (i.e., crosslinking). Crosslinking involves curing the compounded composition at elevated temperature for sufficient time to crosslink the copolymer. Additional curing and annealing can be done during lithium ion battery's typical annealing process. For example, a crosslinked ethylene copolymer may start to be formed and cured using known procedures about 90° C. to about 140° C. for about 60 minutes. Post-cure/annealing heating may be conducted at about 90° C. to about 120° C. for several hours.

An ethylene copolymer or a crosslinked ethylene copolymer can be combined with at least two component solvents to produce a binder for LIB cathodes, one of which would be relatively non-polar and the other would be relatively polar in order to form stable solution and/or concentrate. Non-polar solvents for this application should have fairly low dielectric constant to break down crystallinity caused by polyethylenic structure. Examples of suitable non-polar solvents are diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane and decaline. Relatively polar solvents are to accommodate relatively more polar polymeric structure coming from acrylates. P Typical solvent can be used are acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N, N-dimethyl acetamide, N,N-diethyl acetamide.

Typical method to make binder solution or concentrate is to place pellet, granular or powder form of ethylene copolymer resin in a mixed solvents of non-polar and polar described above. The ratio of non-polar solvent to polar one is from 40:60 to 90:10, preferably from 60:40 to 80:20. The weight percent of polymer in the solution can be from 0.01 wt % to 40 wt %, typically from 5 wt % to 15 wt %. Mechanical stirring or homogenizing is recommended to fully disperse the binder typically under elevated temperature around 50-100 degree Celsius. Heating of binder solution should not be higher than 100 degree Celsius. At above 100 degree Celsius, the decomposition of functionality of ethylene copolymer can be accelerated, which can be detrimental to binder performance.

An ethylene copolymer can generally be combined, dissolved, or dispersed, by any means known to one skilled in the art, in one or more of the solvents illustrated above to produce a slurry composition. If necessary, water may be added to a solvent followed by combining the solvent followed by removing the water in the dispersion medium by distillation or any other known means. The amount of solvent can be adjusted such that the resulting slurry composition can have a viscosity suitable for binding the binder composite with a cathode active material, or an electroconductivity supplying agent, used for the cathode. Generally, the solvent can be present in the slurry from 50 to 90 weight %, more preferably from 70 to 90 weight %. The slurry may also comprise 1 to about 20 weight % of other binders to improve viscosity of the slurry or flexibility of an electrode. Examples of other binder can include a cellulose polymer, a polyacrylonitrile or polymethacrylonitrile, other ethylene copolymer known to one skilled in the art. The preferred weight percent of ethylene copolymer in the solution/dispersion can be from 0.01 wt % to 40 wt %, typically from 5 wt % to 15 wt %. Mechanical stirring or homogenizing is recommended to fully disperse the binder typically under elevated temperature around 50-100° C.

The cathode active material in the slurry composition can be any one known to one skilled in the art. Suitable cathode materials for a lithium ion battery include without limitation lithiated transition metal oxides such as LiCoO₂, LiNiO₂, LiMn₂O₄, or LiV₃O₈; oxides of layered structure such as LiNiₓMn_{y}Co_{z}O₂ where x+y+z is about 1, LiCo_{0.2}Ni_{0.2}O₂, Li_{1+z}Ni_{1-x-y}CoₓAl_{y}O₂ where 0<x<0.3, 0<y<0.1, 0<z<0.06; high voltage spinels such as LiNi_{0.5}Mn_{1.5}O₄ and those in which the Ni or Mn are partially substituted with other elements such as Fe, Ga, or Cr; lithiated transition metal phosphates such as LiFePO₄, LiMnPO₄, LiCoPO₄, LiVPO₄F; mixed metal oxides of cobalt, manganese, and nickel such as those described in U.S. Pat. No. 6,964,828 and U.S. Pat. No. 7,078,128; nanocomposite cathode compositions such as those described in U.S. Pat. No. 6,680,145; lithium-rich layered-layered composite cathodes such as those described in U.S. Pat. No. 7,468,223; and cathodes such as those described in U.S. Pat. No. 7,718,319 and the references therein. Other non-lithium metal compounds can include transition metal sulfides such as TiS₂, TiS₃, MoS₃ and transition metal oxides such as MnO₂, Cu₂V₂O₃, amorphous V₂OP₂O₅, MoO₃, V₂O₅, and V₆O₁₃.

The anode active material in the slurry composition can be any one known to one skilled in the art. Anode active materials can include without limitation carbon materials such as carbon, activated carbon, graphite, natural graphite, mesophase carbon microbeads; lithium alloys and materials which alloy with lithium such as lithium-aluminum alloys, lithium-lead alloys, lithium-silicon alloy, lithium-tin alloy, lithium-antimony alloy and the like; carbon materials such as graphite and mesocarbon microbeads (MCMB); metal oxides such as SnO₂, SnO and TiO₂; and lithium titanates such as Li₄Ti₅O₁₂ and LiTi₂O₄. In one embodiment, the anode active material is lithium titanate or graphite.

Electrically conductive aids may be also added to the slurry to reduce the resistance and increase the capacity of the resulting electrode. Suitable conductive aids include without limitation acetylene black, or furnace black, and carbon fibers and nanotubes.

A cathode active material or the anode active material can be combined with the slurry by any means known to one skilled in the art. The cathode active material or anode active material can be present in the binder composite from 0.1 to 30, 0.5 to 20, or 1 to 10 weight % of the total final composition.

The slurry composition comprising the ethylene copolymer and solvent or the electrode composition comprising the slurry composition and the cathode active material (or anode active material) can be mixed by any means known to one skilled in the art such as, for example, using a ball mill, sand mill, an ultrasonic disperser, a homogenizer, or a planetary mixer.

Any current collector known to one skilled in the art can be used. For example, metals such as iron, copper, aluminum, nickel, and stainless steel can be used. A slurry composition containing the cathode active material or the anode active material disclosed above can be applied or combined onto a current collector followed by drying the slurry and bonding the resultant electrode layer comprising the binder cathode active material or anode active material. Drying can be carried out by any means known to one skilled in the art such as drying with warm or hot air, vacuum drying, infrared drying, or dried with electron beams. The final dry binder layer can be in the range of about 0.0001 to about 6 mm, 0.005 to 5 mm, or 0.01 to 3 mm. Applying a slurry onto a current collector can be carried out by any means known to one skilled in the art such as, for example, using doctor blade, dipping, reverse roll, direct roll, gravure, or brush-painting.

A battery or lithium ion battery can be produced by any means known to one skilled in the art the means thereof is omitted herein for the interest of brevity. An electrolyte may be in a gel or liquid form if the electrolyte is an electrolyte that can be used in a lithium ion battery. The electrolyte typically comprises a lithium salt dissolved in solvent. Known salts include LiClO₄, LiBF₄, LiPF₆, LiCF₃CO₂, LiB(C₂O₄)₂, LiN(SO₂CF₃)₂ LiAsF₆, or LiSbF₆.

### EXAMPLES

### Example 1

### Generation of ELVALOY® AS 10 wt % A Solution in Tetrahydronaphthalene/Ethyl Acetate (5/5) Solvent

ELVALOY® AS, available from DuPont, was dried in vacuum oven at 50° C. and below 10 mmHg for overnight and cooled down under nitrogen condition. A 10 g of dried ELVALOY® AS was placed in a 500 ml three-necked round bottomed flask equipped with a condenser, nitrogen tee, a thermometer and mechanical stirrer. A 45 g of tetrahydronaphthalene and a 45 g of ethyl acetate were added, which were used as purchased. The mixture was slowly stirred by the mechanical stirring. The temperature of the mixture was increased in a rate of 10° C./5 minutes up to 70° C. As resin started to soften, stirring could be intensified appropriately. Stirring was continued for 1.5 hours after the temperature of the mixture reached 70° C. Completely dispersed ELVALOY® AS in co-solvents of tetrahydronathphalene/ethyl acetate was transferred to a glass container with a cap and was allowed to cool down at ambient temperature. Upon cool down, the dispersion formed a wax like paste that could be scooped out easily.

### Example 2

### Fabrication of Cathode of Secondary Battery and Assembly of Coin Cell of Secondary Battery

All parts disclosed here are by weight. Five (5) parts of carbon (Super C65, Timcal, Westlake, Ohio) and 4 parts of ELVALOY® AS with 100 ppm of hexamethylene diamine in a form 10 weight % solution made by the method of example 1 were combined in a vial and mixed using a planetary centrifugal mixer (ARE-310, Thinky USA, Inc., Laguna Hills, Calif.) at 2000 rpm for 2 minutes. Ninety (90) parts of lithium nickel manganese cobalt oxide (NM-1101, Toda America, Battle Creek, Mich.) and additional amount of solvents were added and the slurry again centrifugally mixed at 1000 rpm for 2 minutes. The mixture was further homogenized twice using a rotor-stator (model PT 10-35 GT, 7.5 mm dia. stator, Kinematicia, Bohemia, N.Y.) for 1 minute at 6000 rpm and then for 5 minutes at 9500 rpm. If the temperature of vial increased to more than 70° C., the vial was alternatively placed in an ice bath during homogenization. Finally the slurry was centrifugally mixed again at 1000 rpm for 2 min. Using a doctor coater, the slurry was uniformly applied on the surface of lithium ion battery grade Al foil (1 mil=25.4 micron thickness) that was pre-cleaned by isopropyl alcohol and dichloromethane and gently scratched to facilitate adhesion. The slurry (i.e., dispersion of cathode active material, carbon black, and binder in a solvent) coated cathode was dried in a convection oven (model FDL-115, Binder Inc., Great River, NY) for an hour under ramping temperature from 30° C. to 100° C. The resulting 51-mm wide cathode was placed between 125 μm thick brass sheets and passed through a calendar three times using 100 mm diameter steel rolls at ambient temperature with nip forces increasing in each of the passes, starting at 154 kg with the final pass at 257 kg. The thickness of calendared cathode was about 3 mil. Cathode disks were punched out by using a ½-inch diameter arch punch, and were further dried overnight in a dry-box antechamber under vacuum at 90° C. After 18 hours, inside an Ar (argon) dry box, non-aqueous electrolyte lithium-ion CR2032 coin cells were prepared for electrochemical evaluation. The coin cell parts (case, spacer, wave spring, gasket, and lid) and coin cell crimper were obtained from Hohsen Corp (Osaka, Japan). The anodes were lithium metal (275 μm thick, Chemetall Foote, Kings Mountain, N.C.) and the separator was a microporous polyolefin (CG2325, Celgard, LLC. Charlotte, N.C.). The electrolyte was ethyl methyl carbonate (70 v %) /ethylene carbonate (30 v %)/1 M LiPF6 (Novolyte Purolyte A2 Series, BASF, Independence, Ohio). The cells were cycled using a commercial battery tester (Series 4000, Maccor, Tulsa, Okla.) at ambient temperature using constant current charging and discharging between voltage limits of 3.0-4.25 V at a current of 35 mA per gram of cathode active material (˜0.25 C).

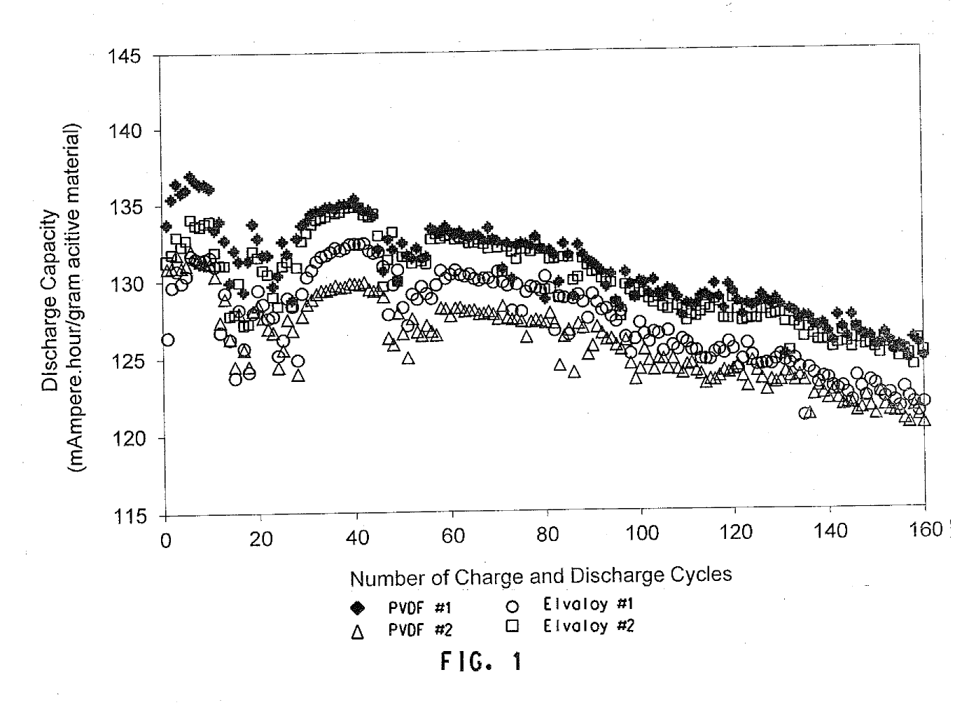

FIG. 1 shows two different coin cells made from cathode active material of NMC (Lithium Nickel Manganese Cobalt Oxide (LiNi0.333Mn0.333Co0.33302) and carbon black (Super C65, Timcal, Westlake, Ohio) by above described methods provided capacity of about 135 mAh/g under 4.25 V charge, 3 V discharge and 0.25 C-rate. The open squares (□) represent coin cell #1 and the open circles (O) represent coin cell #2. Both #1 and #2 were made with ELVALOY® AS as binder. The filled diamonds (♦) represent cell #3 and the open triangles (A) represent cell #4. Coin cells #3 and #4 were made using PVDF as binder. Under same test conditions, the coin cells made with ELVALOY®AS showed almost same discharge capacities and charge/discharge performances as those made with PVDF for over 170 cycles.

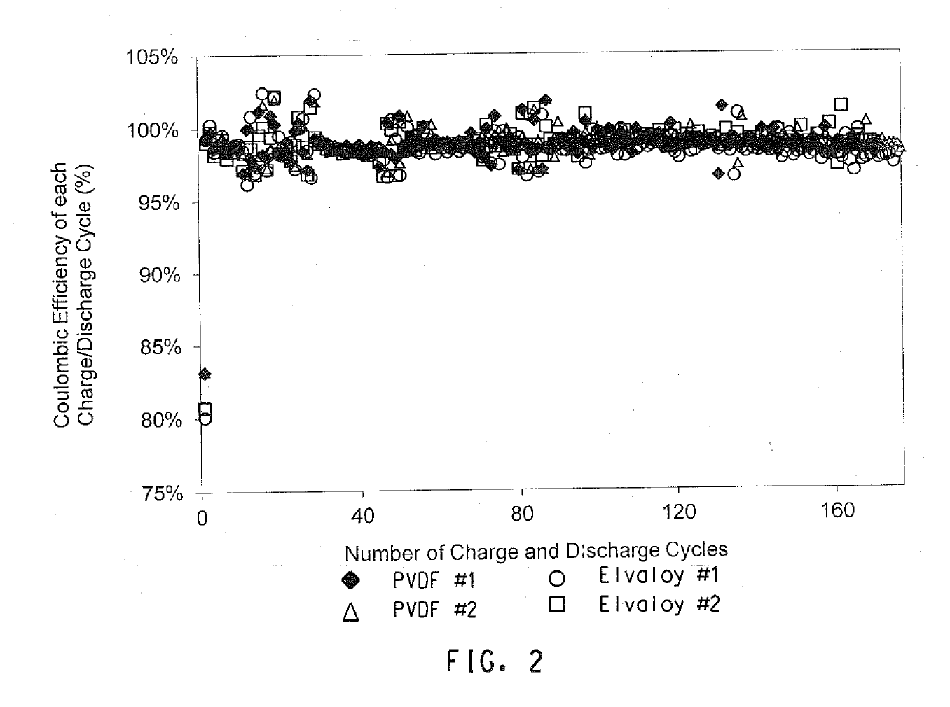

FIG. 2 shows that, under same test conditions, the coin cells made with ELVALOY®AS (cell #1 represented by open squares (□) and cell #2 represented by open circles (O)) showed almost the same Coulombic efficiency (CE) as that made with PVDF (cell #3 represented by filled diamonds (♦) and cell #4 represented by open triangles (A)). CE for each coin cell was about 80% in the first cycle and above about 97% in subsequent cycles.

1. A composition comprising or produced from an ethylene copolymer and a solvent wherein
the composition is a binder for a lithium ion battery;
the copolymer comprises or is produced from repeat units derived from ethylene and a comonomer selected from the group consisting of an ∝, β-unsaturated monocarboxylic acid or its derivative, an ∝, β-unsaturated dicarboxylic acid or its derivative, an epoxide-containing monomer, a vinyl ester, or combinations of two or more thereof;
the monocarboxylic acid, the dicarboxylic acid, or both is optionally neutralized with a metal cation; and
the composition optionally comprises a curing agent.

2. The composition of claim 1 wherein the comonomer is the ∝, β-unsaturated monocarboxylic acid, a derivative of the ∝, β-unsaturated monocarboxylic acid, or combinations thereof

3. The composition of claim 2 wherein the copolymer further comprises or is further produced from repeat units derived from the ∝, β-unsaturated dicarboxylic acid or its derivative.

4. The composition of claim 2 wherein the copolymer is selected from the group consisting of ethylene acrylic acid dipolymer, ethylene methacrylic acid dipolymer, ethylene methyl acrylic acid dipolymer, ethylene ethyl acrylic acid dipolymer, ethylene butyl acrylic acid dipolymer, ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylic acid glycidyl methacrylate terpolymer, ethylene butyl acrylic acid glycidyl methacrylate terpolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, and combinations of two or more thereof.

5. The composition of claim 4 wherein the monocarboxylic acid, the dicarboxylic acid, or both is neutralized with the metal cation to produce an ionomer; and the ionomer is optionally modified with an organic acid or derivative thereof.

6. The composition of claim 4 wherein the copolymer further includes, or is further produced from, the epoxide-containing monomer, the vinyl ester, or combinations thereof.

7. The composition of claim 5 wherein
the composition further comprises or is further produced from the curing agent;
the curing agent is trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, alkylstyrene-maleic anhydride copolymer, polyazelaic polyanhydride, polyether amines, 1, 2, 4-benzenetricarboxylic anhydride, bisphenol A, bisphenol A esters, bisphenol A diglycidyl ether, 1,2-cyclohexanedicarboxylic anhydride, trimethylolpropane tris[poly(propylene glycol), amine terminated] ether, polyamide made from fatty dimer acid, polyamine, triethylenediamine, 2,4,6-tris(dimethylaminomethyl)phenol, liquid polymercaptan, polysulfide resin, a carbodiimide or a derivative thereof, an isocyanides a derivative thereof, or combinations of two or more thereof; and
the solvent is a non-polar solvent, a polar solvent, or combinations thereof; the non-polar group is diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane, decaline, or combinations of two or more thereof; and the polar solvent is acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N, N-dimethyl acetamide, N,N-diethyl acetamide, or combinations of two or more thereof.

8. The composition of claim 7 wherein the copolymer is crosslinked.

9. A lithium ion battery electrode comprising a binder composition and an cathode active material wherein
the binder composition is as characterized in claim 1; and
the cathode active material comprises a lithiated transition metal oxide or lithiated transition metal phosphate, or combinations thereof.

10. The lithium ion battery electrode of claim 9 wherein the comonomer is the ∝, β-unsaturated monocarboxylic acid, a derivative of the ∝, β-unsaturated monocarboxylic acid, or combinations thereof; and the copolymer optionally further comprises or is further produced from repeat units derived from the ∝, β-unsaturated dicarboxylic acid or its derivative.

11. The lithium ion battery electrode of claim 2 wherein the copolymer is selected from the group consisting of ethylene acrylic acid dipolymer, ethylene methacrylic acid dipolymer, ethylene methyl acrylic acid dipolymer, ethylene ethyl acrylic acid dipolymer, ethylene butyl acrylic acid dipolymer, ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylic acid glycidyl methacrylate terpolymer, ethylene butyl acrylic acid glycidyl methacrylate terpolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, and combinations of two or more thereof.

12. The lithium ion battery electrode of claim 11 wherein the monocarboxylic acid, the dicarboxylic acid, or both is neutralized with the metal cation to produce an ionomer; and the ionomer is optionally modified with an organic acid or derivative thereof.

13. The lithium ion battery electrode of claim 12 wherein
the composition further comprises or is further produced from the curing agent;
the curing agent is trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, and its adducts, 5-amino-1,3,3-trimethylcyclohexanemethylamine, alkylstyrene-maleic anhydride copolymer, polyazelaic polyanhydride, polyether amines, 1,2,4-benzenetricarboxylic anhydride, bisphenol A, bisphenol A esters, bisphenol A diglycidyl ether, 1,2-cyclohexanedicarboxylic anhydride, trimethylolpropane tris[poly(propylene glycol), amine terminated] ether, polyamide made from fatty dimer acid, polyamine, triethylenediamine, 2,4,6-tris(dimethylaminomethyl)phenol, liquid polymercaptan, polysulfide resin, a carbodiimide or a derivative thereof, an isocyanides a derivative thereof, or combinations of two or more thereof; and
the solvent is a non-polar solvent, a polar solvent, or combinations thereof; the non-polar group is diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane, decaline, or combinations of two or more thereof; and the polar solvent is acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N, N-dimethyl acetamide, N,N-diethyl acetamide, or combinations of two or more thereof.

14. The composition of claim 13 wherein the copolymer is crosslinked.

15. A lithium ion battery electrode comprising a binder composition and an anode active material wherein
the binder composition is as characterized in claim 1; and
the anode active material comprises a carbon, lithium titanate, Si, Sn, Sb, or alloys or precursors to lithium alloys with Si, Sn, or Sb.

16. The lithium ion battery of claim 15 wherein the comonomer is the ∝, β-unsaturated monocarboxylic acid, a derivative of the ∝, β-unsaturated monocarboxylic acid, or combinations thereof; and the copolymer optionally further comprises or is further produced from repeat units derived from the ∝, β-unsaturated dicarboxylic acid or its derivative.

17. The lithium ion battery of claim 16 wherein the copolymer is selected from the group consisting of ethylene acrylic acid dipolymer, ethylene methacrylic acid dipolymer, ethylene methyl acrylic acid dipolymer, ethylene ethyl acrylic acid dipolymer, ethylene butyl acrylic acid dipolymer, ethylene methyl acrylate dipolymer, ethylene butyl acrylate dipolymer, ethylene methacrylate dipolymer, ethylene methyl methacrylate dipolymer, ethylene glycidyl methacrylate dipolymer, ethylene methyl acrylic acid glycidyl methacrylate terpolymer, ethylene butyl acrylic acid glycidyl methacrylate terpolymer, ethylene methyl acrylate butyl acrylate terpolymer, ethylene methyl acrylate glycidyl methacrylate terpolymer, ethylene butyl acrylate glycidyl methacrylate terpolymer, ethylene methyl acrylate butyl acrylate methyl hydrogen maleate tetrapolymer, ethylene methyl acrylate butyl acrylate ethyl hydrogen maleate tetrapolymer, ethylene methyl acrylate butyl acrylate propyl hydrogen maleate tetrapolymer, ethylene methyl acrylate butyl acrylate butyl hydrogen maleate tetrapolymer, and combinations of two or more thereof.

18. The lithium ion battery electrode of claim 17 wherein the monocarboxylic acid, the dicarboxylic acid, or both is neutralized with the metal cation to produce an ionomer; and the ionomer is optionally modified with an organic acid or derivative thereof.

19. The lithium ion battery electrode of claim 18 wherein
the composition further comprises or is further produced from the curing agent;
the curing agent is trimethylolpropane triglycidyl ether, epoxidized soybean oil, epoxidized linseed oil, m-phenylene diamine, 4,4′-methylenedianiline, hexamethylene diamine, diethylaminopropylamine, dipropylenediamine, n-aminoethyl piperazine, diethylene triamine. triethylene tetramine, tetraethylene pentamine, isophorone diamine, 3-aminophenyl sulfone, 4-aminophenyl sulfone, xylylenediamine and its adducts, 5-amino-1,3,3-trimethylcyclohexanemethylamine, alkylstyrene-maleic anhydride copolymer, polyazelaic polyanhydride, polyether amines, 1,2,4-benzenetricarboxylic anhydride, bisphenol A, bisphenol A esters, bisphenol A diglycidyl ether, 1,2-cyclohexanedicarboxylic anhydride, trimethylolpropane tris[poly(propylene glycol), amine terminated] ether, polyamide made from fatty dimer acid, polyamine, triethylenediamine, 2,4,6-tris(dimethylaminomethyl)phenol, liquid polymercaptan, polysulfide resin, a carbodiimide or a derivative thereof, an isocyanides a derivative thereof, or combinations of two or more thereof; and
the solvent is a non-polar solvent, a polar solvent, or combinations thereof; the non-polar group is diethyl ether, pentane, cyclopentane, hexane, benzene, heptane, cyclohexane, dimethyl cyclohexane, heptane, toluene, octane, ethyl benzene, xylene, 1,4-dioxane, nonane, decane, tetrahydronaphthalene, dodecane, decaline, or combinations of two or more thereof; and the polar solvent is acetone, methyl ethyl ketone, methyl acetate, ethyl acetate, propyl acetate, butyl acetate, hexyl acetate, methyl propionate, butyric acid methyl ester, propylene carbonate, γ-butyrolactone, cyclohexyl acetate, 2-methoxyethyl acetate, ethylene glycol methyl ether acetate, 2-ethoxyethanol acetate, 2-butoxyethanol acetate, diethylene glycol monomethyl ether acetate, propylene glycol methyl ether acetate, ethyl acetoacetate, N-methyl-2-pyrrolidone, N,N-dimethyl formamide, N,N-diethyl formamide, N,N-dimethyl acetamide, N,N-diethyl acetamide, or combinations of two or more thereof.

20. The composition of claim 19 wherein the copolymer is crosslinked.
